(19) United States
(12) Patent Application Publication
(10) Pub. No.: US 2025/0179972 A1
(43) Pub. Date: Jun. 5, 2025

(54) INTERNALLY HEATED ENGINE

(71) Applicant: HENENG (HAINAN) TECHNOLOGY CO., LTD, Hainan (CN)

(72) Inventors: Muze LIN, Beijing (CN); Heyuan LIN, Beijing (CN); Hefei LIN, Beijing (CN)

(73) Assignee: HENENG (HAINAN) TECHNOLOGY CO., LTD, Hainan (CN)

(21) Appl. No.: 18/832,676

(22) PCT Filed: Nov. 15, 2022
(86) PCT No.: PCT/CN2022/131924

§ 371 Date: Feb. 7, 2025

(30) Foreign Application Priority Data
Nov. 4, 2022 (CN) 202211373525.0

(51) Int. Cl. F02G 1/055

(52) U.S. Cl. CPC F02G 1/055

(57) ABSTRACT

An internally heated engine, which comprises a Stirling engine and heating facilities (6, 7); the present engine, by means of altering a means of external heating of the Stirling engine, is provided with said heating facilities (6, 7) in a hot cylinder to push a piston to output power.

### TECHNICAL FIELD

The present disclosure belongs to the technical fields of energy saving and emission reduction, and specifically relates to an internally heated engine.

### BACKGROUND

The Stirling engine was invented by British physicist Robert Stirling in 1816. The Stirling engine is an external combustion engine that outputs power through a cycle of cooling, compression, heat absorption, and expansion in the cylinder. The effective efficiency of the Stirling engine is generally between that of the gasoline engine and that of the diesel engine. The Stirling engine has the following advantages: firstly, the Stirling engine is suitable for various energy sources and fuels, especially for industrial waste heat utilization; secondly, the Stirling engine is low in noise; thirdly, the Stirling engine is not affected by air pressure. The Stirling engine has the following disadvantages: firstly, the Stirling engine is large in heat loss; secondly, the Stirling engine is large in size but low in power; thirdly, the Stirling engine is slow in response. At present, the Stirling engine has been applied in a small amount in various fields such as aerospace, ocean, and solar energy. Many researchers who are keen on and engaged in low-carbon environmental protection have developed plans to recycle industrial waste heat and engine exhaust waste heat by means of the Stirling engine. Due to the disadvantages of the current Stirling engine, the Stirling engine cannot be effectively utilized and popularized.

The purpose of the present disclosure is to convert heat energy with reduced carbon emission into electric energy. An internally heated engine is provided by changing an external heating method of the Stirling engine.

In the present disclosure, all advantages of the Stirling engine are reserved, and the disadvantages of large heat loss, low power, low thermal efficiency, and slow starting are improved. An engine capable of heating and working in a hot cylinder is provided. By changing an external heating method of the Stirling engine, a fixed heating facility is arranged in the hot cylinder, and a heating facility is arranged on a movable piston. During starting, both the fixed heating facility and the movable piston heating facility in the hot cylinder are configured for heating, and heat is dissipated to push the piston to output power. Power is output through a cycle of cooling, compression, heat absorption, and expansion in the cylinder. The piston of the current Stirling engine is usually insulated by means of multiple hollow interlayers, which can not be heated and results in heat loss. In the present disclosure, by heating the piston, a heating area in the hot cylinder is increased, compared with the Stirling engines with similar volumes, more heat can be obtained and higher power can be generated. A thermal insulation device is arranged in the hot cylinder, so the heat loss can be reduced. Due to two-way simultaneous heating, the heating speed is high, and the starting time can also be shortened.

The purpose of the present disclosure is to make full use of industrial waste heat and engine exhaust waste heat to be introduced into the fixed heating facility and the movable piston heating facility of the engine, and in the hot cylinder, the piston is heated and pushed to drive the engine to output power. In burning devices arranged in the fixed heating facility and the movable piston heating facility in the hot cylinder, multiple fuels are burned and heated, so that the engine is driven to operate.

### SUMMARY

### Technical Problem

### Solution for Problem

### Advantageous Effects

### BRIEF DESCRIPTION OF THE DRAWINGS

FIG. 1 is a schematic diagram of an internally heated engine.

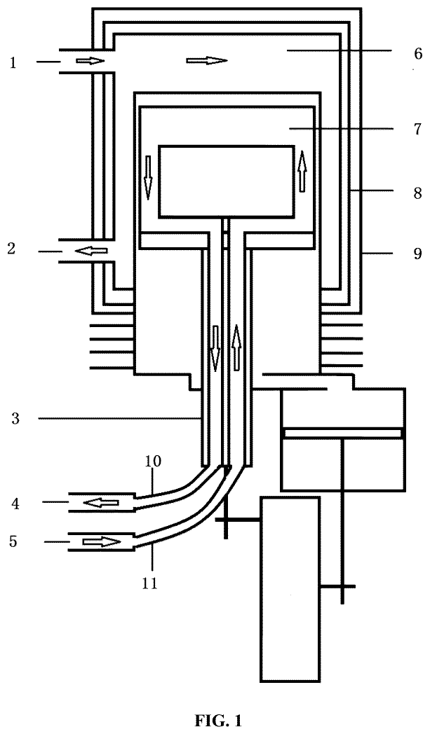

Reference signs: 1, input port; 2, output port; 3, piston connecting rod; 4, output port; 5, input port; 6, fixed heating facility; 7, piston heating facility; 8, thermal insulation layer; 9, external cylinder of hot cylinder; 10, output connection hose; and 11, input connection hose.

### DETAILED DESCRIPTION OF THE EMBODIMENTS

Industrial waste heat and engine exhaust waste heat are utilized and input into the engine as heat sources. One or more engines can be arranged in series through temperature lapse to achieve an expected ideal discharge temperature. Not only the carbon emission is reduced, but also electricity can be generated without consuming energy. The methods are the best implementation. The methods are as follows.

The first method is as follows. A heat source enters a fixed heating device 6 through an input port 1, and heat is dissipated and discharged through an output port 2. Meanwhile, the heat source enters a piston heating facility 7 through an input port 5, an input connection hose 11, and an input channel arranged inside a piston connecting rod 3. Heat is dissipated and discharged from an output port 4 through an output channel inside the piston connecting rod 3 and an output connection hose 10. Both the fixed heating facility 6 and the piston heating facility 7 are configured for heating to push a piston to output power.

The second method is as follows. The second method can be used for multiple fuels. Fuels and oxygen enter through the input port 1. A burning facility is arranged at the fixed heating facility 6. Fuels and oxygen are burned, and heat is dissipated and discharged through the output port 2. Meanwhile, fuels and oxygen enter through the input port 5, the input connection hose 11, and the input channel arranged inside the piston connecting rod 3. A burning device is arranged at the piston heating facility 7. Fuels and oxygen are burned, and heat is dissipated and discharged from the output port 4 through the output channel inside the piston connecting rod 3 and the output connection hose 10. Both the fixed heating facility 6 and the piston heating facility 7 are configured for heating to push the piston to output power.

What is claimed is:

1. An internally heated engine, comprising a Stirling engine and heating devices, wherein the Stirling engine is an engine in which the heating devices are arranged in a hot cylinder;
the heating devices include a movable heating device and/or a fixed heating device arranged in the hot cylinder.
